(19) United States
(12) Patent Application Publication
(10) Pub. No.: US 2007/0233680 A1
(43) Pub. Date: Oct. 4, 2007

(54) Auto-generating reports based on metadata

(75) Inventors: Jason David Carlson, Redmond, WA (US); Carolyn Khanh Chau, Carnation, WA (US); Robert Alan Meyers, Redmond, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/396,174

(22) Filed: Mar. 31, 2006

(51) Int. Cl. G06F 17/30

(52) U.S. Cl. 707/7

(57) ABSTRACT

Mechanisms are provided for auto-generating reports based on metadata. Entities in databases may have some associated metadata, and this metadata may serve as the basis of the reports. Such reports may be generated not only automatically but also dynamically. The generation of reports may also be a function of the role traversal between entities, such that if a role indicates at most one instance of the target entity is related to an instance of the source entity, a single-type report can be created, whereas if the role indicates many instances of the target entity may be related, a different kind or report can be generated, namely, a multi-type report. Lastly, even though reports are auto-generated, such reports can be overridden or customized via user interfaces or application programming interfaces.

### CROSS-REFERENCE TO RELATED SUBJECT MATTER

The present application is related to application Ser. No. ______, filed _, entitled “Drill Through In Any Arbitrary Ad-hoc Report” [Attorney Docket No. MSFT-5575].

### FIELD OF TECHNOLOGY

The present subject matter relates to the field of computing, and more particularly, to databases, although databases are merely an exemplary and non-limiting field of the presently disclosed subject matter.

### BACKGROUND

A database may contain a myriad of entities. Such entities may have various attributes, and may be related in numerous ways, such that aggregations can be performed on them. Sometimes, reports may be desired for such entities, describing a particular entity or its relation to other entities. For example, in a typical warehouse database, one entity may correspond to products, and another entity may correspond to the customers who have purchased those products from the warehouse. The products entity may have attributes such as product identification, product model, product color, and so on; and, the customer entity may have attributes such as first name, last name, phone number, residence, and so on.

If a report is to be generated on what products a particular customer has bought, such a report could detail, for example, the customer's name and all the corresponding product model numbers. Additionally, this report could detail the total sales of all the products—i.e. the aggregate of all the sales of the products. The problem with providing such reports, at least when first deploying a database application, is that it is impractical to custom define reports for each entity—simply because of the vast number of entities (and their corresponding relationships to other entities) in a typical database. Therefore, it would be advantageous to provide mechanisms for auto-generating a report based on information that is already provided with entities, such as metadata.

### SUMMARY

Mechanisms are provided herein for auto-generating a report based on metadata. In one exemplary and non-limiting aspect of the present disclosure, at least one report is provided, where the at least one report comprises of any combination of an identifying information, an attribute information, and an aggregate information. The identifying information can identify an entity, the attribute information can correspond to attributes of the entity (or any related entities), and the aggregate information can correspond to aggregates associated with related entities.

Moreover, at least one metadata associated with the at least one report is provided, where the at least one metadata provides descriptive information about the entity. The at least one metadata can comprise of information relating the entity to at least one other entity. The at least one report is generated automatically and dynamically (at runtime) based on the at least one metadata, where the at least one report can also be configured to be customized by a customization mechanism.

Furthermore, the at least one report can be a single instance-type report that is generated when only one or a small number of instances of the entity will be displayed, or, alternatively, the at least one report can be a multi-instance-type report that is generated when many instances of the entity will be displayed. Interestingly, a user can customize the at least one report using the customization mechanism, or, alternatively, a computing device can customize the at least one report using the customization mechanism.

It should be noted that this Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The foregoing Summary, as well as the following Detailed Description, is better understood when read in conjunction with the appended drawings. In order to illustrate the present disclosure, various aspects of the disclosure are shown. However, the disclosure is not limited to the specific aspects discussed. The following figures are included:

FIG. 1 illustrates a general report auto-generating system, where the system generates reports based on metadata associated with an entity, and where, furthermore, the metadata can provide information about the entity and any associated entities to the entity;

FIG. 2 illustrates an exemplary report that can contain information, such as identification information, attribute information, and aggregate information associated with a particular entity;

FIG. 3 illustrates a single instance-type report that is generated based on a role to an entity, where the role indicates at most one instance of the target entity is related to an instance of the source entity;

FIG. 4 illustrates, in contrast to FIG. 3, a multi-instance-type report that is generated based on a role to an entity, where the role indicates many instances of the target entity can be related to an instance of the source entity;

FIG. 5 illustrates a customization mechanism that allows for the customizing of an auto-generated report; and

FIG. 6 illustrates in block diagram form one exemplary implementation.

### DETAILED DESCRIPTION

Aspects of Auto-Generating a Report Based on Metadata

The terminology used in the presently disclosed subject matter is well known to those of skill in the art. Thus, terms such as “entity,” “attribute,” “aggregation,” “role,” and so on, do not have to be expounded upon, other than to say that an “entity” may be a type or class of information that can be a subject of a query or other database functionality. The entity may have “attributes” (properties) and may be subject to “aggregations” (mathematical manipulations). A join may be the relationship between entities, and a “role” may be the direction of a “join,” and so on. This Detailed Description envisions all kinds of aspects of the subject matter relating to these terms, and those of skill in the art will readily recognize them.

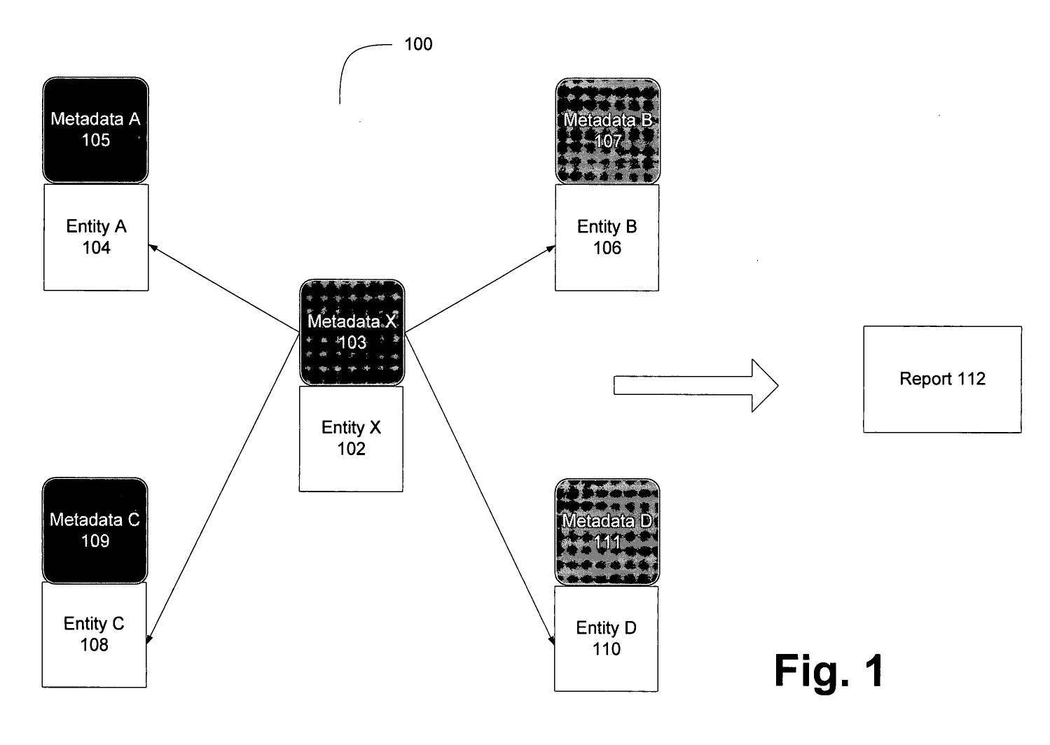

FIG. 1 illustrates a general report auto-generating system 100, where the system 100 generates reports based on metadata associated with an entity, and where, furthermore, the metadata can provide information about the entity and any entities related to the entity. Specifically, entity X 102 is shown, and this entity may have some associated metadata X 103. This metadata X 103 can describe not only interesting attributes of entity X 102, but also relationships of entity X 102 to other entities, such as entity A 104, entity B 106, entity C 108, and entity D 110. As mentioned earlier, a typical database may have a myriad of such entities. The aforementioned metadata X 103 can also describe interesting attributes of other entities, especially how these attributes are associated with entity X 102. Thus, metadata X 103 is shown relating to the other entities 104, 106, 108, 110 via the illustrated arrows.

A report 112 can be created for any particular entity (or a plurality of entities, for that matter). The report can detail not only interesting information for entity X 102, but information for the related entities, as mentioned. This may give the report a type of linking ability to link entity X 102 to the other entities. Thus, various relationships may be displayed in the report 112 that would otherwise not be apparent. This report 112, moreover, can be generated automatically so that no human intervention may be necessary—whether from developers or users. Furthermore, this report 112 can be generated dynamically at runtime, which may obviate the need for provided pre-manufactured reports. As entities change over time, so can their corresponding reports.

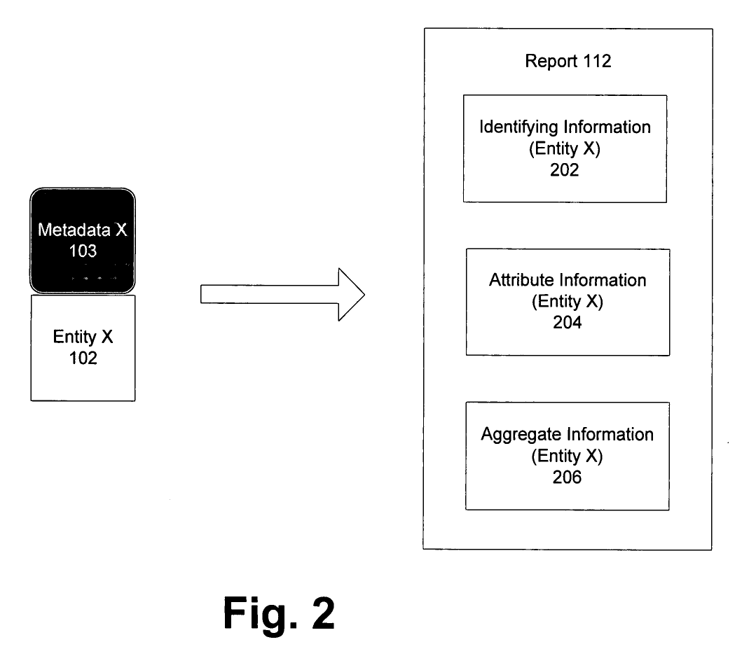

Next, FIG. 2 illustrates an exemplary report that can contain information, such as identification information, attribute information, and aggregate information associated with a particular entity. As mentioned, the metadata X 103 of entity X 102 can be the basis of the report 112. Specifically, the report 112 can comprise at least of identifying information 202 for entity X 102. So, for example, if entity X 102 is a product, then the identifying information can be its model number, or its bar code number, or some other unique identification number or symbol.

Moreover, the report 112 can also list attribute information 204 for entity X 102. This attribute information 204 may provide links to other entities (and hence to the corresponding identification and attribute information). A subset of all the available information may present to a user only the most relevant or apposite content available in the database. As those of skill in the art will readily appreciate, the attribute information 204 may designate, for example, if entity X 102 is a product, the color information, stock information, manufacture information, warranty information, and so on.

Lastly, the report 112 can contain aggregate information 206 for entity X 102. Aggregation information can consist of sums of data, maximum of data, minimum of data, and so on—just about any kind of functionality imaginable in a database. Interestingly, aggregation information may not only be limited to the entity X 102 itself, but may extend to any other related entities in the database. For example, if entity X 102 is a product, then the total sales, total warranties paid, total advertising expenditures, may be aggregated to come up with a final profit for the product.

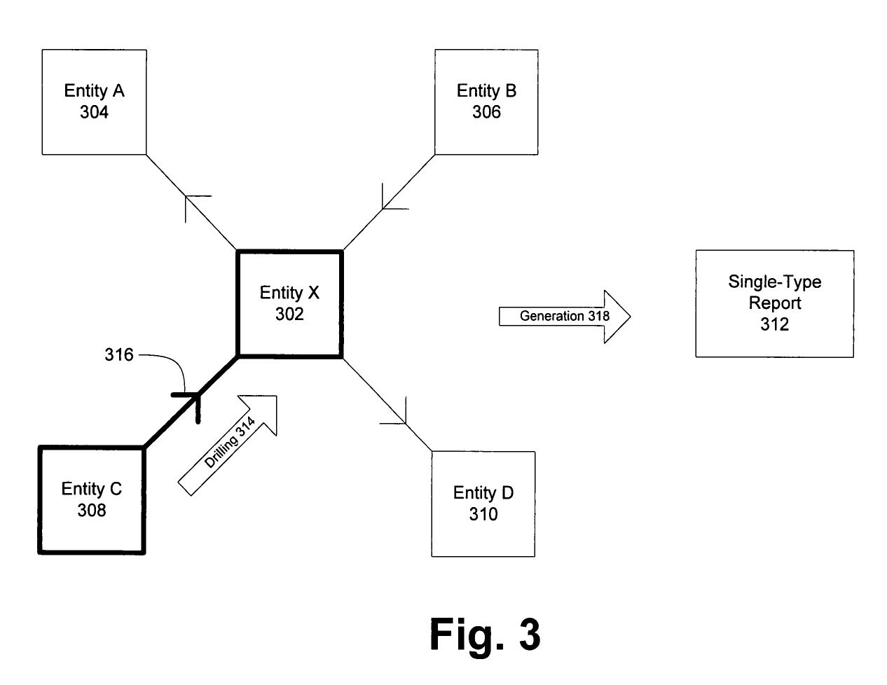

Next, FIG. 3 illustrates a single-instance-type report that is generated based on a role to an entity, where the role indicates at most one instance of the target entity is related to an instance of the source entity. For example, in a typical database query path, entities and roles can be drilled 314 along the path to other entities and roles. In the example illustrated in FIG. 3, five entities are shown: entity A 304, entity B 306, entity C 308, entity D 310, and entity X 302. As is shown in the bold lines in FIG. 3, the drill path 314 is from entity C 308 to entity X 302. The role 316 from entity C 308 to entity X 302 is based on a relationship of many-to-one. In other words, there are many instances of entity C 308 per one instance of entity X 302.

Interestingly, the direction of drilling 314 which determines the cardinality of the target entity relative to an instance of the source entity may directly impact the generation 318 of a report associated with entity X 302. Because the cardinality of the target entity relative to an instance of the source entity in FIG. 3 is one, a “single-type” report 312 is generated 318. This type of report will focus on the single instance of entity X 302 that may correspond to the plurality of instances of entity C 308.

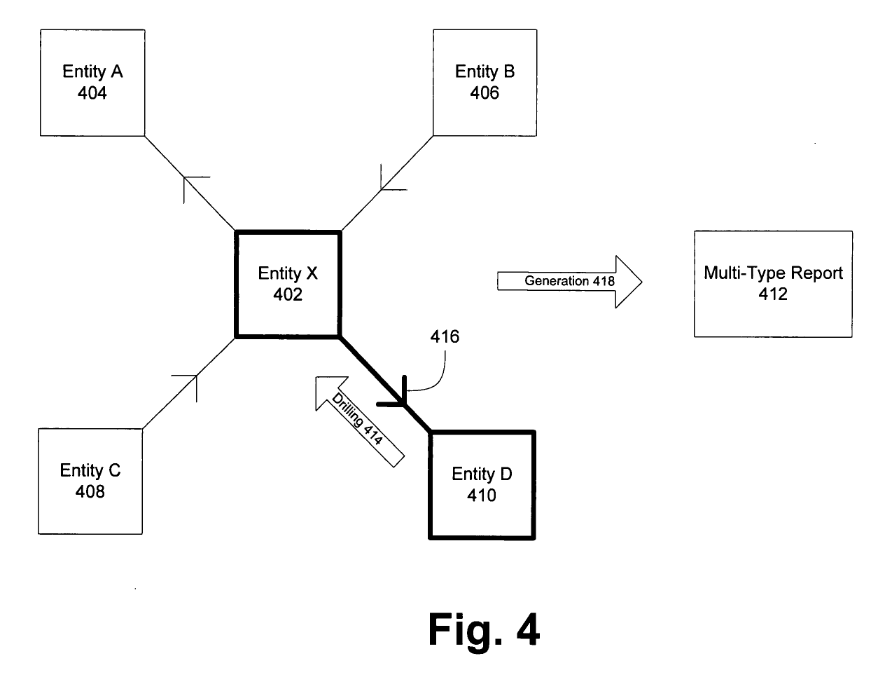

In contrast, FIG. 4 illustrates a multi-type report that is generated based on a role to an entity, where the role indicates many instances of the target entity can be related to an instance of the source entity. Thus, in FIG. 4, the query path would be from entity D 410 to entity X 402. It can be seen that the role between these two entities 402, 410 illustrates a one-to-many relationship, where there are many instances of entity X 402 for any one instance of entity D 410. Because of this, a different type of report will be constructed than in FIG. 3, namely, a multi-type report 412 will be generated 418.

The multi-type report 412 may focus, for example, on all the identification information of all the instances of entity X 402, not so much on the attributes of those instances—since focusing on the attributes of many instances of entity X 402 may deluge the multi-type report 412 to the point that it become unintelligible or uninformative. In contrast, the single-type report 312 of FIG. 3 might focus on such attribute information of entity X, since there is only one instance of entity X from the role of entity C 308.

The multi-type report 412 might focus on aggregation data on all the instances of entity X 402, whether that data may refer to total sales, total model numbers, and so on. In contrast, the single-type report 312 of FIG. 3 might focus more on the relationship of entity X 302 to single instances of other entities, such as entity A 304 and entity D 310 (although, it should be noted that based on the roles between entity X 302, on the one hand, and entities C 308 and B 306, on the other, aggregate information can be gathered between entity X 302 and entity C 308, and between entity X 302 and entity B 306).

In short, a report that is generated for any entity, may depend on the traversal of a role and the cardinality expressed in that role. A single-type report 312 may focus on a single instance of an entity and from there relate any other entities and relevant aggregates. A multi-type report 412, on the other hand, may focus on multiple-instances of an entity of interest, including information such as identification information and any minimal attribute and relevant aggregate information. This much, however, is merely an exemplary summary of the subject matter discussed with reference to FIGS. 3 and 4, and those of skill in the art will readily appreciate the numerous ways in which the single-type reports 312 and multi-type reports 412 could be generated.

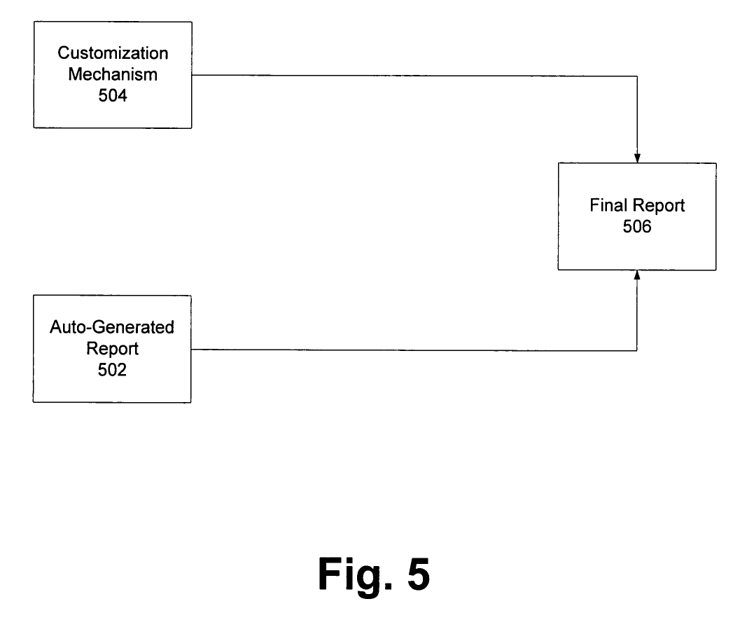

Lastly, FIG. 5 illustrates a customization mechanism 504 that allows for the customizing of a report. So far, in FIGS. 1-4, reports were generated automatically (and dynamically). However, in addition to such generation, reports can be configured so that they may be customized—or, put in other words, they may be overridden from their default state. A default auto-generated reports 502 may be based on some set of default templates. But now, with a customization mechanism 504, these reports can be customized from their default state by users or by computing devices (or modules) into some final reports 506. Users, for example, can set up non-default templates that may be used by the customization mechanism 504 to construct final reports 506.

Aspects of a General Implementation in Block Diagram Form

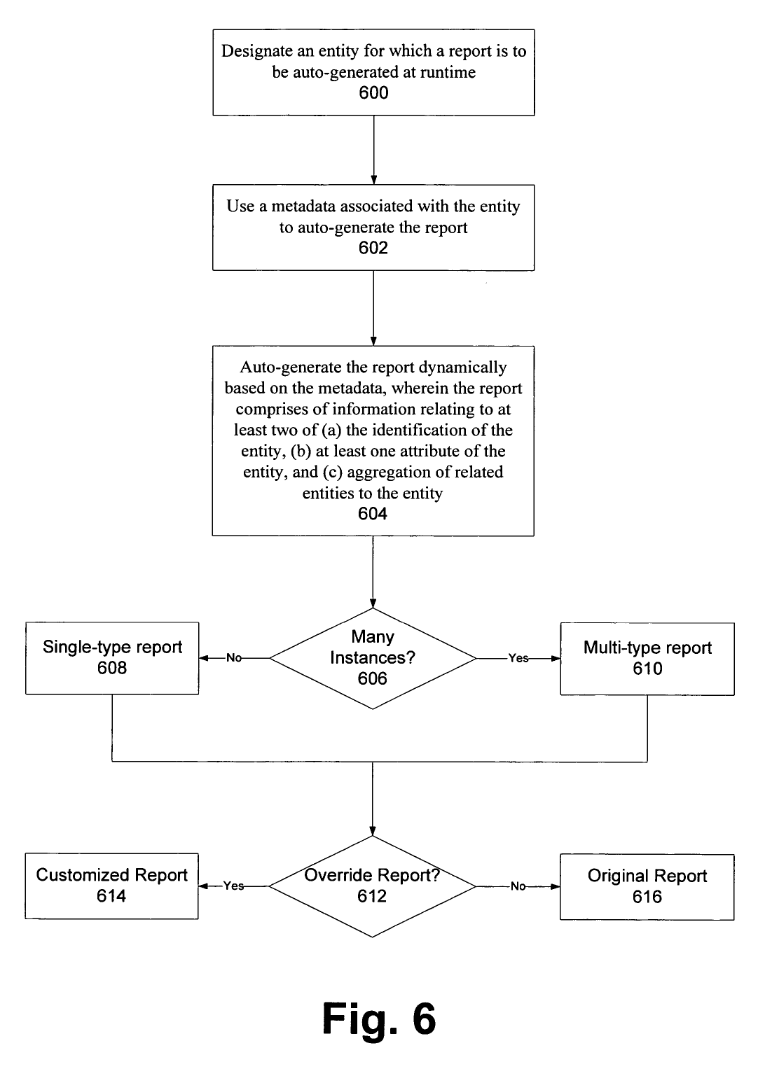

FIG. 6 illustrates in block diagram form one exemplary implementation of auto-generating reports based on metadata. At block, 600, an entity is designated for which a report is to be auto-generated at runtime.

At block 602, metadata is obtained, where the metadata is associated with the entity. The metadata provides information about the various attributes of the entity and its relationships to other entities. Then, at block 604, the report is automatically and dynamically generated based on the metadata, where the report comprises of information relating to some combination of (a) the identification of the entity, (b) at least one attribute of the entity, and (c) aggregation of related entities to the entity.

As the report is about to be generated, its appearance and contents may depend on how roles between entities are being traversed. Thus, at block 606, if a role is traversed along a decreasing cardinality (i.e to a single-instance or few-instances entity), then at block 608 a single-type report (as explained above) is generated. Conversely, if a role is traversed along an increasing cardinality (i.e. to a multi-instance entity), then at block 610 a multi-type report (again, as explained above) is generated.

In either case, whether a single-type report is created, at block 608, or whether a multi-type report is created, at block 610, a decision is made, at block 612, whether an auto-generated report should be overridden—for example, in order to customize the report according to some particular need or standard. If the decision at block 612 is to customize the report, a customized report is generated. Customization can be of two sorts: 1) on the front-end where non-default templates are used to generate reports (as discussed with reference to FIG. 5), and 2) on the back-end where customization can be performed by a user via a user interface, or it may be performed by some computing device or module via some application programming interface, in order to change an already generated report. However, if the decision at block 612 is not to customize the report, then at block 616 the report is left in its original auto-generated state.

The various systems, methods, and techniques described herein may be implemented with hardware or software or, where appropriate, with a combination of both. Thus, the methods and apparatus of the present subject matter, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the subject matter. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present subject matter may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, such as that shown in the figure below, a video recorder or the like, the machine becomes an apparatus for practicing the present subject matter. When implemented on a general-purpose processor, the program code combines with the processor to provide a unique apparatus that operates to perform the indexing functionality of the present subject matter.

Lastly, while the present disclosure has been described in connection with the preferred aspects, as illustrated in the various figures, it is understood that other similar aspects may be used or modifications and additions may be made to the described aspects for performing the same function of the present disclosure without deviating therefrom. For example, in various aspects of the disclosure, auto-generation of reports based on metadata was discussed. However, other equivalent mechanisms to these described aspects are also contemplated by the teachings herein. Therefore, the present disclosure should not be limited to any single aspect, but rather construed in breadth and scope in accordance with the appended claims.

What is claimed:

1. A system for auto-generating reports based on metadata, comprising:
at least one report, wherein the at least one report comprises of at least an identifying information, an attribute information, and an aggregate information; and
at least one metadata associated with the at least one report, wherein the at least one metadata provides descriptive information about an entity, and wherein the at least one report is generated automatically and dynamically based on the at least one metadata, wherein furthermore, the at least one report is configured to be customized by a customization mechanism.

2. The system according to claim 1, wherein the at least one report is a single-type report.

3. The system according to claim 1, wherein the at least one report is a multi-type report.

4. The system according to claim 1, wherein a user customizes the at least one report using the customization mechanism.

5. The system according to claim 1, wherein a computing device customizes the at least one report using the customization mechanism.

6. The system according to claim 1, wherein the at least one metadata comprises of information relating the entity to at least one other entity.

7. The system according to claim 1, wherein the customization mechanisms provides an application programming interface for customizing the at least one report.

8. The system according to claim 1, wherein the customization mechanisms provides a user interface for customizing the at least one report.

9. A method for auto-generating reports based on metadata, comprising:
designating an entity for which a report is to be auto-generated at runtime;
using a metadata associated with the entity to auto-generate the report;
auto-generating the report dynamically based on the metadata, wherein the report comprises of information relating to at least two of (a) the identification of the entity, (b) at least one attribute of the entity, and (c) aggregation of related entities to the entity; and
providing an override mechanism, wherein the override mechanism is configured to override a default report.

10. The method according to claim 9, wherein the auto-generating results in a report that is a single-type report.

11. The method according to claim 9, wherein the auto-generating results in a multi-type report.

12. The method according to claim 9, wherein providing the override mechanism is configured to allow a user to customize the report via a user interface.

13. The method according to claim 9, wherein providing the override mechanism is configured to allow a computing device to customize the report via an application programming interface.

14. The method according to claim 9, wherein using the metadata is using information that relates the entity to at least one other entity.

15. A computer readable medium for executing tangible computer readable instructions for auto-generating reports based on metadata, comprising:
a first instruction for identifying an entity for which a report is to be generated;
a second instruction for using metadata associated with the entity; and
a third instruction for generating automatically at runtime the report, wherein the report is generated based on the metadata that has information about the identity of the entity and the attributes of the entity, wherein furthermore, the report is generated based on a selected subset of the metadata; and
a fourth instruction for providing an override mechanism for customizing the automatically generated report.

16. The computer readable medium according to claim 15, wherein the third instruction results in a single-type report.

17. The computer readable medium according to claim 15, wherein the third instruction results in a multi-type report.

18. The computer readable medium according to claim 15, wherein the override mechanism is configured to allow a user to customize the report via a user interface.

19. The computer readable medium according to claim 15, wherein the override mechanism is configured to allow a computing device to customize the report via an application programming interface.

20. The computer readable medium according to claim 15, wherein the metadata additionally contains information that leads to data that can be aggregated.
